(19) United States
(12) Patent Application Publication
(10) Pub. No.: US 2006/0046920 A1
(43) Pub. Date: Mar. 2, 2006

(54) Silicon carbide sintered product and method for production thereof

(75) Inventor: Fumio Odaka, Niiza-Saitama (JP)

Correspondence Address: SUGHRUE MION, PLLC, 2100 PENNSYLVANIA AVENUE, N.W., SUITE 800, WASHINGTON, DC, 20037, US

(73) Assignee: Bridgestone Corporation, Chuo-ku, Tokyo (JP)

(21) Appl. No.: 10/534,531

(22) PCT Filed: Nov. 12, 2003
(86) PCT No.: PCT/JP03/14371

§ 371 Date: May 12, 2005

(30) Foreign Application Priority Data
Nov. 12, 2002 (JP) 2002-328214
Oct. 2, 2003 (JP) 2003-344849

(51) Int. Cl. C04B 35/573

(52) U.S. Cl. 501/88; 264/643

(57) ABSTRACT

A silicon carbide sintered body, wherein the porosity obtained from areas of silicon carbide particles and silicon particles in a sectional polished surface of the silicon carbide sintered body is greater than 15% and less than 30%, when the porosity (%) equals (the area of silicon particles/(the area of silicon particles+the area of silicon carbide particles))×100; and a content of residual silicon is less than 4% to a total volume of the silicon carbide sintered body.

The application is based upon and claims the benefit of priority from the prior Japanese Patent Applications, that is, Japanese Patent Application Publication Nos. 2002-328214, filed on Nov. 12, 2002 and 2003-344849, filed on Oct. 2, 2003 submitted by the same patent applicant; the entire contents of which are incorporated herein by reference.

### TECHNICAL FIELD

The present invention relates to a silicon carbide sintered body and a manufacturing method thereof.

### BACKGROUND ART

A silicon carbide sintered body has been applied variously; however, in some technical fields, a range of applications of the silicon carbide sintered body has been restricted. For instance, in the application where it is exposed to such a high temperature as 1420° C. that is the melting point of silicon or more, it is feared that residual silicon in a silicon carbide sintered body may elute. As a result, a range of applications of the silicon carbide sintered body has been restricted.

In order to overcome the foregoing problems, some technologies have been proposed (for instance, patent documents 1 and 2).

Patent document 1: Japanese Patent Application Laid-Open No. 59-184768

Patent document 2: Japanese Patent Application Laid-Open No. 63-30386

However, since the foregoing problems have not yet been overcome, as means for further improving the heat resistance and the reliability of the silicon carbide sintered body, a reduction in an amount of the residual silicon in the silicon carbide sintered body has been demanded.

Furthermore, in some technical fields, from viewpoints of making the variation smaller in the mechanical characteristics, the electrical characteristics and the thermal characteristics of the silicon carbide sintered body, the uniform dispersibility of silicon particles in a texture of the silicon carbide sintered body has been demanded.

### DISCLOSURE OF INVENTION

The present invention relates to items described below.
[1] A silicon carbide sintered body, wherein
   the porosity obtained from areas of silicon carbide particles and silicon particles in a sectional polished surface of the silicon carbide sintered body is greater than 15% and less than 30%, when the porosity (%) equals(the area of silicon particles/(the area of silicon particles+the area of silicon carbide particles))×100; and
   a content of residual silicon is less than 4% to a total volume of the silicon carbide sintered body.
[2] The silicon carbide sintered body according to the item [1] above, wherein
   a total content of impurity elements other than silicon and carbon in the silicon carbide sintered body is less than 10 ppm.
[3] The silicon carbide sintered body according to item [1] or [2] above, wherein a content of nitrogen is greater than 150 ppm.
[4] A manufacturing method of a silicon carbide sintered body that uses a reaction sintering method, comprising
   (1) dissolving and dispersing silicon carbide powder in a solvent, followed by pouring an obtained slurry-like powder mixture in a mold, further followed by drying to obtain a green body, (2) calcining the obtained green body under a vacuum atmosphere or an inert gas atmosphere at a temperature in the range of 1200° C. to 1800° C. to obtain a calcined body 1, (3) impregnating the obtained calcined body 1 with a carbon source, (4) calcining a calcined body 2 impregnated with a carbon source, (5) reaction sintering where the obtained calcined body 2 is impregnated with molten metallic silicon and free carbon in the calcined body 2 and silicon are reacted to obtain a silicon carbide body, and (6) heating in a vacuum atmosphere at a temperature in the range of 1450° C. to 1700° C. for 30 to 90 minutes to remove unreacted silicon.

### BRIEF DESCRIPTION OF THE DRAWINGS

FIG. 1 is a diagram showing a state of dispersion of SiC particles and Si particles in a texture of a silicon carbide sintered body obtained according to reference example 1.

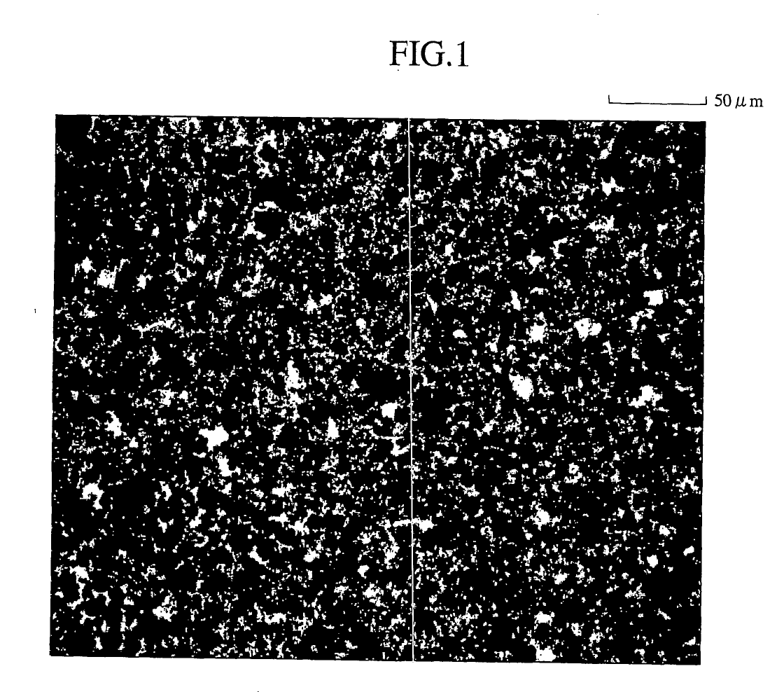

FIG. 2 is a diagram showing a state of dispersion of SiC particles and Si particles in a texture of a silicon carbide sintered body obtained according to example 2.

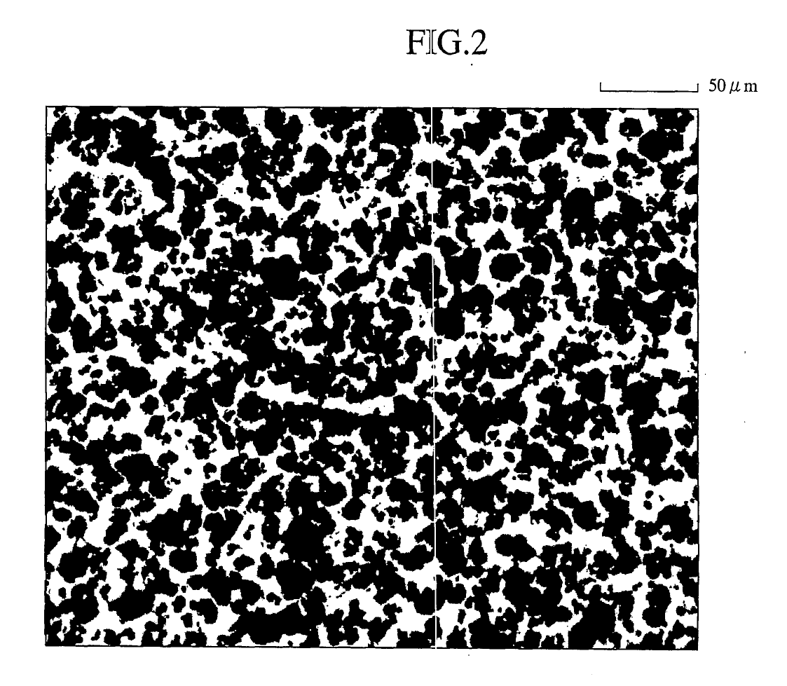

### BEST MODE FOR CARRYING OUT THE INVENTION

The present inventors, after studying hard, found that when a manufacturing method in which a calcined body containing silicon carbide and carbon is impregnated with metallic silicon, followed by subjecting carbon and silicon to the reaction sintering to obtain a silicon carbide sintered body further includes heating to remove unreacted silicon, the foregoing problems can be overcome. In what follows, the present invention will be further detailed. In the beginning, ingredients that are used in the manufacture of a silicon carbide sintered body according to the invention will be explained.

(Silicon Carbide Powder)

As silicon carbide powder that can be used in the invention, α-, β-, amorphous-silicon carbide or a mixture thereof can be cited. Furthermore, in order to obtain a high purity silicon carbide sintered body, as a raw material silicon carbide powder, high purity silicon carbide powder is preferably used.

A grade of the β-silicon carbide powder is not particularly restricted. For instance, commercially available β-silicon carbide powder can be used. A particle diameter of the silicon carbide powder is, from a viewpoint of obtaining a higher density, preferably smaller. Specifically, it is in the range of substantially 0.01 to 10 μm, and more preferably in the range of 0.05 to 5 μm. When the particle diameter is less than 0.01 μm, in measuring and mixing processes, it can be handled with difficulty. When it exceeds 10 μm, a specific surface area becomes smaller, that is, a contact area with adjacent powder becomes smaller, unfavorably resulting in difficulty of obtaining higher density.

The high purity silicon carbide powder can be obtained, for instance, by a process in which a silicon source that contains at least one kind of silicon compound, a carbon source that includes at least one kind of organic compound that generates carbon upon heating and a polymerizing or cross-linking catalyst are dissolved in a solvent, followed by drying, further followed by sintering the obtained powder under a non-oxidizing atmosphere.

As the silicon source including the foregoing silicon compounds (hereinafter, referred to as a “silicon source”), liquid one and solid one may be used together; however, at least one kind of liquid one has to be selected. As the liquid one, polymers of alkoxysilane (mono-, di-, tri-, tetra-) and tetra-alkoxysilane are used. Among the alkoxysilanes, tetra-alkoxysilane is preferably used. Specifically, methoxysilane, ethoxysilane, propoxysilane, buthoxysilane and the like can be cited. From a viewpoint of the handling, ethoxysilane is preferable. Furthermore, as the polymer of tetra-alkoxysilane, low molecular weight polymers having the degree of polymerization of substantially 2 to 15 (oligomers) and liquid silicate polymers further higher in the degree of polymerization can be cited. As solid ones that can be used in combination with these, silicon oxide can be cited. In the foregoing reaction sintering, the silicon oxide includes, other than SiO, silica gel (colloidal ultra-fine silica-containing liquid including inside thereof a OH group and alkoxy group), silicon dioxide (silica gel, fine silica, quartz powder) and the like. These silicon sources may be used singularly or in combination of two or more kinds.

Among these silicon sources, from viewpoints of the excellent homogeneity and handling convenience, an oligomer of tetra-ethoxysilane and a mixture of an oligomer of tetra-ethoxysilane and fine powdery silica are preferable. Furthermore, as these silicon sources, high purity substances are used, ones of which initial impurity content is 20 ppm or less is preferable, and ones of which initial impurity content is 5 ppm or less is more preferable.

The polymerizing and crosslinking catalysts that are used to manufacture the high purity silicon carbide powder can be properly selected in accordance with the carbon sources. When the carbon source is a phenolic resin or a furan resin, acids such as toluenesulfonic acid, toluenecarboxylic acid, acetic acid, exalic acid, and sulfuric acid can be cited. Among these, toluenesulfonic acid can be preferably used.

When the high purity silicon carbide powder that is raw material powder used in the foregoing reaction sintering method is manufactured, a ratio of carbon to silicon (hereinafter, abbreviated as C/Si ratio) can be defined by applying the elemental analysis to a carbide intermediate obtained by carbonizing the mixture at 1000° C. Stoichiometrically, when the C/Si ratio is 3.0, free carbon in generated silicon carbide should be 0%. However, in actuality, owing to sublimation of simultaneously generated SiO gas, free carbon is generated at lower C/Si ratios. It is important that a compounding ratio is beforehand determined so that an amount of free carbon in the generated silicon carbide powder may not be an amount that is not appropriated for manufacturing a sintered body. Normally, in the sintering at approximately 1 atmosphere and at 1600° C. or more, when the C/Si ratio is set in the range of 2.0 to 2.5, the free carbon can be suppressed; accordingly, this range can be preferably used. When the C/Si ratio is set at greater than 2.55, the free carbon increases drastically; however, the free carbon has an effect of suppressing the grain growth; accordingly, in accordance with an intended grain growth size, the C/Si ratio may be properly selected. However, when a pressure of the atmosphere is set lower or higher, the C/Si ratio for obtaining pure silicon carbide varies; accordingly, in this case, the C/Si ratio is not necessarily restricted to the foregoing range.

From the foregoing, as a method of obtaining particularly high purity silicon carbide powder, a manufacturing method of high purity silicon carbide powder that includes a manufacturing method of raw material powder described in a manufacturing method of a single crystal according to Japanese Patent Application Laid-Open No. 09-48605 previously applied by the present applicant, that is, generating silicon carbide in which with at least one kind selected from high purity tetra-alkoxysilane and tetra-alkoxysilane polymers as a silicon source and with a high purity organic compound that generates carbon upon heating as a carbon source, a mixture obtained by homogeneously mixing thereof is heated and sintered under a non-oxidizing atmosphere to generate silicon carbide powder; and applying aftertreatment in which a process in which the obtained silicon carbide powder is kept at a temperature equal to 1700° C. or more and less than 2000° C., and during the temperature is kept, a process of heating at a temperature in the range of 2000° C. to 2100° C. for 5 to 20 min is applied at least once; wherein
by carrying out the foregoing two steps, silicon carbide powder contents of the respective impurities in which are 0.5 ppm or less can be obtained. Silicon carbide powder thus obtained is irregular in the size thereof; accordingly, crushing and classification are applied to make the size conform to the foregoing particle size.

When nitrogen is introduced during silicon carbide powder is manufactured, in the beginning, a silicon source, a carbon source and an organic compound made of a nitrogen source and a polymerizing or crosslinking catalyst are homogeneously mixed. As mentioned above, when a carbon source such as a phenolic resin, an organic compound made of a nitrogen source such as hexamethylene tetramine and a polymerizing or crosslinking catalyst such as toluenesulfonic acid are dissolved in a solvent such as ethanol, a silicon source such as an oligomer of tetra-ethoxysilane is preferably mixed sufficiently.

(Carbon Source)

A substance that is used as a carbon source is preferably a high purity organic compound that has oxygen in a molecule and leaves carbon when it is heated. Specifically, a phenolic resin, a furan resin, an epoxy resin, a phenoxy resin, and various kinds of saccharides such as monosaccharide such as glucose, oligosaccharides such as sucrose, and polysaccharides such as cellulose and starch can be cited. From an object of homogeneously mixing thereof with a silicon source, one that is liquid at normal temperature, one that can be dissolved in a solvent, or one that softens or becomes liquid owing to heating such as thermoplastic or thermally melting one is mainly used. Among these, a resole type phenolic resin and a novolac type phenolic resin can be preferably used. In particular, the resole type phenolic resin can be preferably used.

(Silicon Source)

As a silicon source, at least one kind selected from high purity tetra-alkoxysilane, a polymer thereof and silicon oxide is used. In the invention, the silicon oxide includes silicon dioxide and silicon monoxide. As the silicon source, specifically, alkoxysilanes typical in tetra-ethoxysilane, a low molecular weight polymer thereof (oligomer), a silicate polymer further higher in the degree of polymerization, and a silicon oxide compound such as silica gel and particulate silica can be cited. As the alkoxysilane, methoxysilane, ethoxysilane, propoxysilane and buthoxysilane can be cited. Among these, from the viewpoint of the handling convenience, ethoxysilane is preferably used.

Here, the oligomer means a polymer having a degree of polymerization in the range of substantially 2 to 15. Among these silicon sources, from the excellent homogeneity and handling convenience, an oligomer of tetra-ethoxysilane and a mixture of tetra-ethoxysilane and particulate silica can be preferably used. Furthermore, as the silicon source, one high in the purity is used, that is, an initial content of the impurities is preferably less than 20 ppm and more preferably less than 5 ppm.

(Manufacturing Method of Silicon Carbide Sintered Body)

Subsequently, a manufacturing method of a silicon carbide sintered body owing to a reaction sintering method according to the invention will be described with reference to embodiments.

An embodiment of a manufacturing method of a silicon carbide sintered body according to the present invention includes (1) dissolving and dispersing silicon carbide powder in a solvent, followed by pouring an obtained slurry-like powder mixture in a mold, further followed by drying to obtain a green body, (2) calcining the obtained green body under a vacuum atmosphere or an inert gas atmosphere at a temperature in the range of 1200° C. to 1800° C. to obtain a calcined body 1, (3) impregnating the obtained calcined body 1 with a carbon source, (4) calcining a calcined body 2 impregnated with a carbon source, (5) reaction sintering where the obtained calcined body 2 is impregnated with molten metallic silicon and free carbon in the calcined body 2 and silicon are reacted to obtain a silicon carbide body, and (6) heating in a vacuum atmosphere at a temperature in the range of 1450° C. to 1700° C. for 30 to 90 minutes to remove unreacted silicon. In what follows, regarding the embodiment of a manufacturing method of a silicon carbide sintered body, the respective steps will be detailed.

(1) Obtaining a Green Body

Silicon carbide powder and a defoamer are dissolved or dispersed in a solvent to manufacture a slurry-like powder mixture. In this case, from a viewpoint of homogeneously dispersing pores in a green body, it is preferable to thoroughly agitate and mix. The agitation/mixing can be carried out by use of a known agitation/mixing unit such as a mixer and a planetary ball mill. The agitation/mixing is preferably carried out over 6 to 48 hours, in particular, over 12 to 24 hours.

As the silicon carbide powder that is used in the obtaining a green body, the foregoing silicon carbide powder can be cited. As the solvent, water, lower alcohols such as ethyl alcohol, ethyl ether and acetone can be cited. As the solvent, one less in the content of impurity is preferably used. As the defoamer, a silicone defoamer and the like can be cited. Furthermore, when a slurry-like powder mixture is manufactured from silicon carbide powder, an organic binder may be added. As the organic binder, a deflocculant, a particulate adhesive and the like can be cited. As the deflocculant, from a viewpoint of further improving an effect of imparting the electrical conductivity, a nitrogen-base compound such as ammonia and ammonium polyacrylate can be preferably used. As the particulate adhesive, a polyvinyl alcohol urethane resin (such as water-soluble polyurethane) can be preferably used.

Next, after the slurry-like powder mixture is poured into a mold, left and demolded, the solvent is removed by drying to manufacture a green body. In this case, in order to pour the slurry-like powder mixture into a mold for molding, in general, cast molding is used. After the slurry-like powder mixture is poured in a cast molding die, left and demolded, it is heated and dried under a temperature condition in the range of 40° C. to 60° C. or left drying naturally to remove the solvent. Thereby, a green body having a specified dimension can be obtained. In the invention, the “green body” means a silicon carbide molded body prior to subjecting to the reaction sintering, the molded body obtained by removing the solvent from the slurry-like powder mixture having a lot of pores inside thereof.

(2) Obtaining a Calcined Body 1

The green body is calcined to obtain a calcined body 1. The calcination is carried out at a temperature in the range of 1200° C. to 1900° C., preferably in the range of 1200° C. to 1800° C. and more preferably in the range of 1500° C. to 1800° C. When the temperature is less than 1200° C., since in the green body, silicon carbide particles are not sufficiently accelerated in coming into contact each other, the contact strength becomes insufficient to result in inconvenience in the handling. Furthermore, when it exceeds 1900° C., grain growth of the silicon carbide powder in the green body becomes remarkable, resulting in, thereafter, causing insufficiency in penetration of molten high purity silicon.

A temperature rising speed of the foregoing calcining is preferably in the range of 1 to 3° C./min up to 800° C. and 5 to 8° C./min from 800° C. to the maximum temperature. A retention time at the maximum temperature of the foregoing calcination is preferably in the range of 10 to 120 min and more preferably in the range of 20 to 60 min. The foregoing temperature rising speed and the retention time at the maximum temperature can be properly determined in consideration of a shape and a size of the green body. The calcination is preferably carried out in a vacuum atmosphere or an inert gas atmosphere from a viewpoint of inhibiting oxidation. In the invention, the “calcined body 1” is a silicon carbide molded body before the reaction sintering is applied, which is obtained by calcining the green body, from which pores and impurities are removed and which does not contain a carbon source. On the other hand, the “calcined body 2” described later is a silicon carbide molded body before the reaction sintering is applied, which is obtained by calcining the foregoing calcined body 1 after the carbon source is impregnated. Accordingly, it is obvious that the “calcined body 1” and the “calcined body 2” have to be discriminated. The bending strength of the calcined body 1 obtained in the foregoing (2) is, in a preferable mode, greater than 20 MPa.

(3) Impregnating a Calcined Body 1 with a Phenolic Resin

The calcined body 1 is impregnated with a phenolic resin as a carbon source to manufacture a calcined body 1 impregnated with the phenolic resin. An impregnation method, as far as the calcined body 1 can be impregnated with a phenolic resin, is not particularly restricted; however, it is preferable to impregnate a phenolic resin by making use of the capillary phenomenon. It is further preferable to impregnate the calcined body 1 with a phenolic resin by making use of a cold isostatic press (CIP). When the capillary phenomenon is utilized, the larger a size of a finally obtained silicon carbide sintered body, the larger a difference of densities of a periphery portion and a central portion; accordingly, a silicon carbide sintered body having homogeneous density tends to be difficult to obtain. On the other hand, when the calcined body 1 is impregnated with a phenolic resin by use of the cold isostatic press (CIP) method, even when a volume of a silicon carbide sintered body is large, a silicon carbide sintered body having homogeneous density can be obtained without limit. Accordingly, from a viewpoint that the calcined body 1 can be homogeneously impregnated with a phenolic resin without being affected by a size of a finally obtained silicon carbide sintered body, the cold isostatic press (CIP) method can be preferably used.

When the calcined body 1 is impregnated with a phenolic resin as a carbon source by use of the cold isostatic press (CIP) method, by use of a conventional cold isostatic press (CIP) processor, according to steps below, the calcined body 1 can be impregnated with a phenolic resin.

In the beginning, the calcined body 1 and a phenolic resin as a carbon source is poured into a flexible mold. After the mold is closely sealed, a phenolic resin is added into the flexible mold by an amount that is in excess than a calculated value obtained by considering an actual carbon ratio and can sufficiently immerse the green body. Specifically, it is preferable to add in the flexible mold at a ratio of the calcined body 1:the phenolic resin=1:3 to 6 (by volume ratio). As the foregoing flexible mold, one that can at least be closely sealed and apply pressure on a substance accommodated in the mold from all directions and simultaneously is used. Specifically, a rubber mold or a rubber glove can be preferably used. Furthermore, as the phenolic resin, a liquid resole phenolic resin can be preferably used. Next, the sealed mold is placed in a pressure chamber of a pressure vessel and a pressurizing liquid is filled in, followed by sealing with a plug of the pressure vessel. As the pressurizing liquid, a highly compressible liquid can be used. Specifically, from the viewpoints of higher compressibility and excellent operability, water or a 30% boric acid aqueous solution can be preferably used. Thereafter, by applying a cold isostatic press (CIP) process under predetermined conditions, the calcined body 1 is impregnated with a carbon source. When the cold isostatic press (CIP) process is carried out, it is preferable that at room temperature, a pressure is raised up to 1000 to 5000 kg/cm² over 1 hours, followed by holding the foregoing conditions for 0.5 hours. When the pressure is 1000 kg/cm² or less, the impregnation becomes insufficient, and when it is 5000 kg/cm² or more, destruction may occur when lowering the pressure. More preferably, the pressure is raised up to 2500 to 3500 kg/cm² over 2 hours, followed by holding under the foregoing conditions for 1 hour to apply the cold isostatic press (CIP) process. At this time, it is preferable to lower the pressure over 2 hours after holding under the predetermined pressure.

By applying the cold isostatic press (CIP) process, a phenolic resin as a carbon source can be homogeneously impregnated in an entirety of the calcined body 1, resulting in improving the purity of a silicon carbide sintered body that is obtained as a final product. In the invention, the “cold isostatic press (CIP) process (method)” means a processing method that, by making use of an equilibrium pressure or a hydrostatic pressure, homogeneously applies a high pressure on an entire surface of the molded body. In the cold isostatic press (CIP) process, other than a process that uses the liquid medium as a pressure medium, there is one that uses a gas medium. As far as conditions of the foregoing cold isostatic press (CIP) process are satisfied, a processing method that uses a gas medium can be used; however, from an economical point of view, it is preferable to apply the cold isostatic press (CIP) process with a liquid medium.

(4) Obtaining a Calcined Body 2

The calcined body 1 that is obtained by the foregoing (3) and impregnated with a phenolic resin is calcined to obtain a calcined body 2. Owing to the calcination, a carbon component that contributes to the reaction sintering can be obtained. The calcination is carried out at a temperature in the range of 900° C. to 1400° C., preferably in the range of 900° C. to 1200° C. and more preferably in the range of 950° C. to 1100° C. When the temperature is less than 900° C., the carbonization becomes unfavorably insufficient. Furthermore, when the temperature exceeds 1400° C., since the carbonization is over, it is unfavorable from an economical point of view. The temperature rising speed of the calcination is preferably 2 to 4° C./min up to 600° C. and 8 to 10° C./min from 600° C. to the maximum temperature. However, it can be properly determined by considering a shape and a size of the calcined body 1. The retention time at the maximum temperature of the calcination is preferably in the range of 10 to 60 min and more preferably in the range of 20 to 30 min. However, it can be properly determined by considering a shape and a size of the calcined body 1. The calcination is preferably carried out in a vacuum atmosphere or an inert gas atmosphere from a viewpoint of inhibiting the oxidation.

The bending strength of the calcined body 2 obtained in the foregoing (4) is greater than 20 MPa and, in a more preferable mode, greater than 23 MPa. Thus, since the calcined body 2 has the mechanical strength enough to tentatively mold, when the calcined body 2 is tentatively molded, finally the moldability of a silicon carbide sintered body can be improved. That is, an improvement in the mechanical strength of the calcined body 2 enables to improve the moldability.

When the foregoing (3) impregnating the calcined body 1 with a phenolic resin and the (4) calcining are repeated, a conversion rate to SiC becomes higher and thereby the mechanical strength of a finally obtained silicon carbide sintered body can be improved.

(5) Obtaining a Silicon Carbide Body

The calcined body 2 manufactured through the step (4) is heated in a vacuum atmosphere or an inert gas atmosphere at a temperature equal to or more than a melting point of high purity metallic silicon, specifically, in the range of 1450° C. to 1700° C. to immerse in molten high purity metallic silicon to manufacture a silicon carbide body (sintered body). When the calcined body 2 is immersed in the molten metallic silicon, liquefied silicon permeates into pores in the calcined body 2 due to the capillary phenomenon to react with free carbon in the calcined body 2. Owing to the reaction, silicon carbide is generated and thereby the pores in the calcined body 2 are filled by the generated silicon carbide.

A reaction between silicon and free carbon, as shown in the step of manufacturing silicon carbide powder, occurs at a temperature equal to or more than the melting point of silicon; accordingly, molten high purity metallic silicon heated to a temperature in the range of 1450° C. to 1700° C., after permeating into the calcined body 2, reacts with the free carbon. Furthermore, a time period during which the calcined body 2 is immersed in the molten metallic silicon is not particularly restricted and can be properly determined depending on a size and an amount of the free carbon in the calcined body 2. The high purity metallic silicon is heated to 1450° C. to 1700° C., preferably to 1550° C. to 1650° C. to melt. When a melting temperature is less than 1450° C., because the viscosity of the high purity metallic silicon goes up unfavorably, the capillary phenomenon becomes difficult to permeate the high purity metallic silicon into the calcined body 2. Furthermore, when the melting temperature exceeds 1700° C., the vaporization becomes remarkable to unfavorably damage a furnace and the like.

As the high purity metallic silicon, powdery, granular and agglomerate metallic silicon can be cited, and among these, 2 to 5 mm agglomerate metallic silicon can be preferably used. In the invention, the “high purity” means to be less than 1 ppm in the content of impurities.

As mentioned above, when the free carbon in the calcined body 2 and silicon are reacted and thereby pores in the calcined body 2 are filled by generated silicon carbide, a silicon carbide sintered body high in the density and excellent in the electrical characteristics can be obtained.

(6) Removing Unreacted Silicon

The silicon carbide sintered body manufactured through the step (5) is heated to a temperature equal to or more than the melting point of metallic silicon, preferably in the range of 1450° C. to 1700° C. and more preferably in the range of 1600° C. to 1700° C. to remove unreacted silicon. When the heating temperature is less than 1450° C., an amount of residual silicon increases and unreacted silicon seeps out on a surface of the silicon carbide sintered body. Furthermore, when the heating temperature is higher than 1700° C., the mechanical strength (MPa) of the silicon carbide sintered body deteriorates. In this case, as the heating time, it is preferable to keep for 30 to 90 min at the foregoing heating temperature, and more preferable to keep for substantially 60 min, for instance, 50 to 70 min.

Furthermore, when the unreacted silicon is removed under atmospheric pressure, unreacted silicon sublimated by heating tends to deposit on a work surface; accordingly, the unreacted silicon is preferably removed under a vacuum atmosphere. Still furthermore, when high purity carbon wool or the like is disposed around to protect a furnace, the sublimated silicon reacts with the carbon wool and can be captured by the carbon wool.

As an optional step, in addition to the foregoing (1) through (6), a hydrofluoric acid process may be further disposed. When the hydrofluoric acid process is disposed to elute the unreacted silicon in hydrofluoric acid, the unreacted silicon that cannot be removed in the foregoing step (5) can be removed. A washing condition in this case is properly determined depending on a shape and size of the work. However, when taking the operating efficiency and a time necessary for washing after the hydrofluoric acid process into consideration, it is preferable to completely remove the unreacted silicon in the step (6). When ultrasonic is combined in the washing, the washing efficiency can be further improved.

(Silicon Carbide Sintered Body)

According the foregoing reaction sintering method, a silicon carbide sintered body that is high in the purity, density and toughness, electrically conductive and can be machined by the electric discharge machining can be obtained. In the foregoing reaction sintering method, there is no particular restriction on a manufacturing device as far as it can satisfy the foregoing heating conditions of the invention; that is, known heating furnaces or reaction devices can be used.

Thus obtained silicon carbide sintered body is less in an amount of the residual silicon. Furthermore, the foregoing silicon carbide sintered body has a structure in which silicon carbide particles are uniformly dispersed. That is, the porosity of the silicon carbide sintered body is less than 30%. The porosity of the silicon carbide sintered body is greater than 10% and less than 30%, and preferably greater than 15% and less than 20%. When the porosity exceeds the above-mentioned upper limit, an amount of the residual silicon increases, and the mechanical strength of the silicon carbide sintered body is likely to decrease. An amount of the residual silicon in the silicon carbide sintered body is less than 30% by volume of the silicon carbide sintered body. Accordingly, the heat resistance and the reliability of the silicon carbide sintered body are improved, resulting in expanding a range of applications of products. The porosity in the invention means a value that is obtained according to an equation below after from a micrograph of a polished sectional surface of a silicon carbide sintered body by means of the image processing areas of silicon carbide particles and silicon particles are obtained.
Porosity (%)=(area of silicon particles/(area of silicon particles+area of silicon carbide particles))×100

Area ratios of silicon carbide and silicon of the silicon carbide sintered body (section/surface) are greater than 70% for the silicon carbide area and less than 30% for the silicon area.

Furthermore, an amount of the residual silicon in the silicon carbide sintered body is less than 4%, preferably less than 2% to a total volume of the silicon carbide sintered body. When it exceeds 4%, there is a fear in that the residual silicon may elute during high temperature use. The lower limit of the amount of the residual silicon in the silicon carbide sintered body is not particularly restricted; however, it is substantially 0.5%. Since the reaction between Si and C causes a volume contraction, it is difficult to make the amount of the residual silicon less than 0.5%.

The silicon carbide sintered body obtained according to the invention has the density of 2.9 g/cm³ or more and a structure in which mainly isotropic silicon particles having an average particle diameter in the range of 2 to 8 μm are uniformly dispersed. Accordingly, it can be used also as a structural member small in the fluctuation of the density and the like. It is reported that in general, when the density of the sintered body is less than 2.9 g/cm³, the mechanical characteristics such as the bending strength and the rupture strength and the electrical physical properties deteriorate, and furthermore an increase in particles increases contamination. Accordingly, the silicon carbide sintered body according to the invention can be said to have excellent mechanical and electrical characteristics. The density of the silicon carbide sintered body according to the invention in a preferable mode is greater than 3.0 g/cm³. Furthermore, when an obtained sintered body is porous, physical disadvantages such that the heat resistance, the oxidation resistance, the chemical resistance and the mechanical strength are poor, the washing is difficult, microcracks are caused and fragments become contaminant, and the gas permeability is generated are caused, resulting in restricting applications. In the silicon carbide sintered body according to the invention, the foregoing disadvantages due to the porous body are difficult to occur.

A total content of the impurities in the silicon carbide sintered body obtained according to the invention is less than 1.0 ppm, preferably less than 5 ppm, more preferably less than 3 ppm and still more preferably less than 1 ppm. From a viewpoint of applying to the semiconductor industrial field, the impurity contents according to the chemical analysis have meaning only as a reference value. From a practical point of view, evaluation differs depending on whether the impurity distribution is homogeneous or locally predominant. Accordingly, in general, one skilled in the art, by use of a practical device, variously evaluates whatever degree the impurity contaminates a wafer under a predetermined heating condition. According to a manufacturing method in which a solid material obtained by homogeneously mixing a liquid silicon compound, a nonmetal sintering additive and a polymerizing or crosslinking catalyst is heated to carbonize under a non-oxidizing atmosphere, followed by further sintering under a non-oxidizing atmosphere, a total content of impurities other than silicon, carbon and oxygen contained in the silicon carbide sintered body can be made less than 1 ppm. A content of nitrogen in the silicon carbide sintered body obtained according to the invention is greater than 150 ppm.

The silicon carbide sintered body thus obtained according to the invention preferably has the following physical properties. The silicon carbide sintered body according to the invention is less than 1 Ω cm in the volume resistance, and, in a more preferable mode, in the range of 0.5 to 0.05 Ω cm. In the silicon carbide sintered body according to the invention, a total content of inevitable elements other than silicon and carbon of the silicon carbide sintered body, that is, impurity elements is less than 5 ppm. In the silicon carbide sintered body according to the invention, the density is greater than 2.9 g/cm³, and in a more preferable mode in the range of 3.00 to 3.15 g/cm³. In the silicon carbide sintered body according to the invention, the bending strength is greater than 200 MPa, and in a more preferable mode greater than 220 MPa. The sintered body obtained according to the foregoing manufacturing method, according to applications, can be subjected to processes such as the machining, polishing and washing. The sintered body according to the invention can be manufactured by forming into a cylindrical sample (sintered body) followed by slicing in a diameter direction. As a machining method, the electrical discharge machining can be preferably used. Resultant ones can be used in semiconductor manufacture components, electronic information instrument components, optical components and the like.

As principal semiconductor manufacturing devices in which the sintered body components according to the invention can be used, an exposing device, a resist processor, a dry etching device, a washing device, a heater, an ion implanter, a CVD device, a PVD device, a dicing machine and the like can be cited. Examples of components include a plasma electrode for a dry etching device, a protector ring (focus ring), a slit component for an ion implanter (aperture), a protection plate for an ion generator and a mass analyzer, a dummy wafer that is used when a wafer is processed in a heater and a CVD device, and a heat-generater in a heater, a CVD device and a PVD device, in particular a heater that directly heats a lower portion of a wafer can be cited. As the components for electronic information instrument, a disc base plate for a hard disc device, a thin film magnetic head base plate and the like can be cited. Furthermore, as the optical components, a mirror for reflecting synchrotron radiation (SR), laser light and the like can be cited.

In each of silicon carbide powder that is raw material powder of the invention, a silicon source and a nonmetal sintering additive for manufacturing the raw material powder, and an inert gas that is used to obtain a non-oxidizing atmosphere, as the purity thereof, a content of each of the respective impurity elements is preferably 1 ppm or less. However, when these are within allowable limits of purification in the heating and sintering, it is not restricted thereto. Furthermore, the impurity elements here include elements that belong to group I to group XVI in the periodic table according to 1989 IUPAC inorganic chemistry nomenclature revised edition and have an atomic number of 3 or more, except for elements having an atomic number of 6 to 8 and 14 to 16.

In the foregoing, embodiments are illustrated and described; however, it is obvious that the present invention is not restricted to the foregoing embodiments.

### EXAMPLES

In what follows, examples and comparative examples will be shown to detail the present invention; however, it is obvious that the present invention is not restricted to examples below.

### Example 1

Preparation of Silicon Carbide Sintered Body

In accordance with the manufacturing method of the silicon carbide sintered body described in the foregoing detailed explanation, a silicon carbide sintered body was manufactured under conditions shown below.

In the beginning, to 100 parts of high purity silicon carbide powder, as a silicon source, having a center particle diameter 5 μm (silicon carbide that is manufactured according to a manufacturing method described in Japanese Patent Application Laid-Open No. 09-48605 and has an impurity content of 5 ppm or less/1.5% by weight of silica), 40 parts of water, 0.3 parts of deflocculant and 3 parts of binder were added, followed by dispersing and mixing for 24 hours by use of a ball mill, and thereby a slurry-like powder mixture having the viscosity of 1 poise was obtained.

The slurry-like powder mixture was cast in a plaster mold having a length of 60 mm, a width of 10 mm and a thickness of 5 mm, followed by naturally drying at 22° C. for 24 hr, and thereby a green body was obtained.

Next, the obtained green body was heated, in a graphite crucible having an inner diameter of 200 mm and a height of 80 mm, under an argon atmosphere, to 1800° C. over 10 hours and calcined at the foregoing temperature for 1 hour to obtain a calcined body 1.

Subsequently, as a phenolic resin, a resole type phenolic resin (Trade name “SK Light” manufactured by Sumitomo Chemical Co., Ltd.) was poured in a rubber mold by an amount of six times a volume of a molded body, followed by applying a cold isostatic press process (CIP) at a pressure of 1.2 ton, and thereby the foregoing sintered body 1 was impregnated with the phenolic resin.

After the CIP process, the calcined body 1 impregnated with the phenolic resin was calcined similarly to the above at 1200° C. to obtain a calcined body 2. Next, by use of metallic silicon as a silicon source, at 1540° C., a Si impregnation process was carried out to obtain a reaction sintered body. Furthermore, under a vacuum atmosphere, the reaction sintered body was heated to 1450° C., followed by keeping at the temperature for 60 min to remove unreacted silicon, and thereby a silicon carbide sintered body was obtained.

Then, of the obtained silicon carbide sintered body, according to criteria described below, the porosity, the residual silicon, the exudation, the mechanical strength, the average particle diameter, and the density were observed. The processing temperature and processing time conditions in the removing unreacted silicon, and obtained experimental results are shown in Table 1.

### Examples 2 and 3

### Comparative Examples 1 Through 4

Experiments were carried out similarly to example 1 except that the processing temperature and time in the removing unreacted silicon were set at conditions shown in Table 1. The processing temperature and time conditions in the removing the unreacted silicon and obtained experimental results are shown in Table 1.

TABLE 1
Heating and removing condition of unreacted silicon

| | | Example | Example | Example | Comparative | Comparative | Comparative | Comparative |
|---|---|---|---|---|---|---|---|---|
| | | 1 | 2 | 3 | example 1 | example 2 | example 3 | example 4 |
| Condition | Processing | 1450 | 1600 | 1700 | 1400 | 1950 | 1600 | 1600 |
| | temperature (° C.) | | | | | | | |
| | Retention time (min) | 60 | 60 | 60 | 60 | 60 | 20 | 100 |
| Results | Porosity (%) | 30 | 29.6 | 28.9 | 32 | 35 | 33 | 34 |
| | Residual silicon (%) | 3.9 | 3 | 2.1 | 5 | 1.5 | 4.8 | 1.7 |
| | Exudation | None | None | None | Yes | None | Yes | None |
| | Mechanical strength | 263 | 250 | 230 | 185 | 135 | 180 | 138 |
| | (MPa) | | | | | | | |
| | Average particle | 5.0 | 5.0 | 5.0 | 8.0 | 8.0 | 8.0 | 8.0 |
| | diameter of SiC | | | | | | | |
| | particle (μm) | | | | | | | |
| | Density (g/cm³) | 2.95 | 2.95 | 2.95 | 2.86 | 2.86 | 2.86 | 2.86 |

Notes
When the exudation of silicon was observed after a sample was kept for 30 min at 1500° C. under an argon atmosphere, it is noted as “Yes” and when exudation was not observed, it is noted as “None”.

(Experimental Results)

From the foregoing experimental results, it was found as following.

Comparison between examples 1 and 3 and comparative examples 1 and 2:

According to examples 1 and 3, it is found that when the heating is applied at a temperature in the range of 1450° C. to 1700° C. for 60 min, a silicon carbide sintered body that does not exhibit the exudation of silicon and has sufficient mechanical strength can be obtained.

On the other hand, according to comparative examples 1 and 2, it is found that even when the processing time is 60 min, when a processing temperature is 1400° C., the exudation of silicon is observed and when the processing temperature is at 1950° C., a silicon carbide sintered body having insufficient mechanical strength can be obtained.

Comparison between Example 2 and comparative examples 3 and 4:

According to example 2, it is found that when the heating is applied at 1600° C. for 60 min, a silicon carbide sintered body having excellent mechanical strength can be obtained without causing the exudation of silicon.

On the other hand, according to comparative examples 3 and 4, it is found that even though the processing temperature is set at 1600° C., when the processing time is 20 min, the exudation of silicon is observed, and when the processing time is 100 min, though the exudation of silicon is not observed, a silicon carbide sintered body having insufficient mechanical strength can be obtained.

(Evaluation Criteria)

(1) Measurement of the Porosity (Surface Observation)

A section of the obtained silicon carbide sintered body was polished, of a superficial layer at 0.5 mm from a surface of the section of the silicon carbide sintered body, in a viewing field range of a rectangle of 340 μm×250 μm, by use of a digital image processor (trade name: LUZEX, manufactured by Nireco Corporation), the image analysis was applied. From areas of silicon carbide particles and silicon particles in a sectional polished surface of the silicon carbide sintered body in the foregoing viewing field, the porosity was obtained according to a formula, porosity (%)=(area of silicon particles/(area of silicon particles+area of silicon carbide particles))×100.

(2) Residual Silicon (%)

Similarly to the measurement of the (1) porosity, a surface observation of the silicon carbide sintered body was carried out and the residual silicon (%) was obtained by volume base.

(3) Exudation of Silicon

A silicon carbide sintered body was kept under an argon atmosphere at 1500° C. for 30 min. Whether the exudation of silicon was caused on a surface of the silicon carbide sintered body or not was observed. When the exudation of silicon was observed, it was evaluated as “Yes” and, when the exudation was not observed it was evaluated as “none”.

(4) Mechanical Strength

In accordance with JIS R1601, according to a three point bending test, the bending strength (MPa) of the silicon carbide sintered body was measured.

(5) Average Particle Diameter

Similarly to the measurement of the foregoing (1) porosity, a surface observation was applied to the silicon carbide sintered body and by means of the image analysis an average particle diameter (μm) of SiC particles was obtained.

(6) Density

The density (g/cm³) was measured by an Archimedes' Method in accordance with JIS R1634.

### INDUSTRIAL APPLICABILITY

According to the present invention, the heat resistance and the reliability of a silicon carbide sintered body can be improved.

Furthermore, according to the invention, a silicon carbide sintered body having a structure in which silicon particles are uniformly dispersed can be provided.

One skilled in the art can easily understand that what are mentioned above are preferable embodiments of the present invention and many modifications and corrections can be applied without deviating from a spirit and a range of the present invention.

1. A silicon carbide sintered body, wherein
the porosity obtained from areas of silicon carbide particles and silicon particles in a sectional polished surface of the silicon carbide sintered body is greater than 15% and less than 30%, when the porosity (%) equals (the area of silicon particles/(the area of silicon particles+the area of silicon carbide particles))×100; and
a content of residual silicon is less than 4% to a total volume of the silicon carbide sintered body.

2. The silicon carbide sintered body according to claim 1, wherein
a total content of impurity elements other than silicon and carbon in the silicon carbide sintered body is less than 10 ppm.

3. The silicon carbide sintered body according to claim 1, wherein a content of nitrogen is greater than 150 ppm.

4. A manufacturing method of a silicon carbide sintered body that uses a reaction sintering method, comprising
dispersing silicon carbide powder in a solvent, followed by pouring an obtained slurry-like powder mixture in a mold, further followed by drying to obtain a green body,
calcining the obtained green body under a vacuum atmosphere or an inert gas atmosphere at a temperature in the range of 1200° C. to 1800° C. to obtain a calcined body 1,
impregnating the obtained calcined body 1 with a carbon source,
calcining a calcined body 2 impregnated with a carbon source,
reaction sintering where the obtained calcined body 2 is impregnated with molten metallic silicon and free carbon in the calcined body 2 and silicon are reacted to obtain a silicon carbide body, and
heating in a vacuum atmosphere at a temperature in the range of 1450° C. to 1700° C. for 30 to 90 minutes to remove unreacted silicon.

5. The silicon carbide sintered body according to claim 1, wherein the bending strength is greater than 200 MPa.

6. The silicon carbide sintered body according to claim 1, further comprising a structure in which silicon particles are uniformly dispersed.

7. The silicon carbide sintered body according to claim 1, wherein the porosity is greater than 15% and less than 20%.

8. The manufacturing method of a silicon carbide sintered body according to claim 4, wherein in the heating to remove unreacted silicon a temperature is kept in the range of 1600° C. to 1700° C. for 50 to 70 minutes to remove the unreacted silicon.

9. The manufacturing method of a silicon carbide sintered body according to claim 4, wherein the obtained silicon carbide sintered body has the bending strength of greater than 200 MPa.

10. The manufacturing method of a silicon carbide sintered body according to claim 4, wherein the obtained silicon carbide sintered body has a structure where silicon particles are uniformly dispersed.

11. The manufacturing method of a silicon carbide sintered body according to claim 4, wherein the obtained silicon carbide sintered body has the porosity of greater than 15% and less than 20%.
